(19) United States
(12) Patent Application Publication
(10) Pub. No.: US 2026/0054786 A1
(43) Pub. Date: Feb. 26, 2026

(54) HIGH MOBILITY ROBOT WITH ARTICULATED CHASSIS

(71) Applicants: Eagle Technology, LLC, Melbourne, FL (US); Florida State University Research Foundation, Inc., Tallahassee, FL (US)

(72) Inventors: Paul Bosscher, West Melbourne, FL (US); Jonathan Clark, Tallahassee, FL (US); Christian Hubicki, Tallahassee, FL (US)

(21) Appl. No.: 18/809,797

(22) Filed: Aug. 20, 2024

(51) Int. Cl. B62D 57/028

(52) U.S. Cl. CPC B62D 57/028

(57) ABSTRACT

A mobile platform (MP) and method for operating same. The MP comprising: a chassis which extends in a longitudinal direction from a back end to a front end and extends in lateral directions from a platform centerline to two opposing lateral sides (wherein the chassis comprises body parts configured to rotate relative to each other); limbs coupled to the chassis; and wheels connected to the limbs. Each limb is movable in a first direction towards the platform centerline and a second direction away from the platform centerline such that a stance of a front or rear pair of limbs can be selectively narrowed and widened.

### BACKGROUND

### Description of the Related Art

Unmanned ground vehicles (UGVs) are being used for an increasing number of tasks, including those involving site security, inspection, emergency response, law enforcement and intelligence/surveillance and reconnaissance (ISR). Consequently, mission objectives for UGVs can involve numerous operational requirements, many of which can be conflicting in nature. For example, UGVs should be highly mobile to not only facilitate mobility on obstacles and irregular terrain (e.g., climbing stairs) and small enough to fit into tight areas (e.g., going through doors and stairwells), but also have the ability to carry heavy payloads for extended periods of time).

### SUMMARY

This document concerns mobile platform(s). The mobile platform(s) comprise(s): a chassis which extends in a longitudinal direction from a back end to a front end and extends in lateral directions from a platform centerline to two opposing lateral sides (wherein the chassis comprises a plurality of body parts configured to rotate relative to each other); a plurality of limbs coupled to the chassis and a plurality of wheels respectively connected to the plurality of limbs. Each limb of the plurality of limbs is movable in a first direction towards the platform centerline and an opposing second direction away from the platform centerline such that a stance of a front or rear pair of limbs can be selectively narrowed and widened.

This document also concerns method(s) for controlling or operating a mobile platform. The method(s) comprise(s): causing, by a circuit, the mobile platform to traverse terrain; rotating a plurality of body parts of a chassis relative to each other as the mobile platform traverses the terrain (wherein the chassis extends in a longitudinal direction from a back end of the mobile platform to a front end of the mobile platform and extends in lateral directions from a platform centerline to two opposing lateral sides of the mobile platform); and narrowing or widening a stance between first and second limbs of the mobile platform by actuating at least a first mechanical joint provided at a first point of articulation between the chassis and an upper limb member of the first limb that is coupled to the chassis.

### BRIEF DESCRIPTION OF THE DRAWINGS

This disclosure is facilitated by reference to the following drawing figures, in which like numerals represent like items throughout the figures.

FIG. 1 provides an illustration of a system having a mobile platform.

FIG. 2 provides a side perspective view of the mobile platform of FIG. 1.

FIG. 3 provides a front view of the mobile platform shown in FIGS. 1-2.

FIGS. 4A-4C (collectively referred to as “FIG. 4”) provides a series of illustrations that are useful for understanding movement of the mobile platform shown in FIGS. 1-3 for transitioning between a narrow stance and a wide stance.

FIG. 5 provides an illustration showing adjustable stances of the mobile platform of FIGS. 1-4.

FIG. 6 provides an illustration showing waist twisting of the mobile platform of FIGS. 1-5.

FIGS. 7A-7D (collectively referred to herein as “FIG. 7”) provides illustrations showing a mobile platform traversing terrain in accordance with the present solution.

FIG. 8 provides an illustration showing the mobile platform with two roll joints and the mobile platform with one roll joint.

FIG. 9 provides an illustration showing tracks that were interchanged with the wheels of the mobile platform.

FIG. 10 provides a flow diagram of an illustrative method for operation and/or controlling a mobile platform.

FIG. 11 provides a block diagram of an illustrative computing device.

### DETAILED DESCRIPTION

It will be readily understood that the components of the systems and/or methods as generally described herein and illustrated in the appended figures could be arranged and designed in a wide variety of different configurations. Thus, the following more detailed description, as represented in the figures, is not intended to limit the scope of the present disclosure, but is merely representative of certain implementations in various different scenarios. While the various aspects are presented in the drawings, the drawings are not necessarily drawn to scale unless specifically indicated.

Unmanned ground vehicles (UGVs) need to be able to perform a variety of different tasks and operations without becoming unstable and tipping over. Various conventional approaches have been applied to solve this problem. For example, some conventional mobility platforms include wheels and tracks. These mobility platforms have relatively good endurance, payload capacity, speed, and mobility over different surfaces (e.g., mud and snow). However, they have relatively poor mobility on obstacles and in unstructured terrain. Other conventional mobility platforms include legs. These mobility platforms have relatively good mobility over different surfaces (e.g., mud and snow), on obstacles and in unstructured terrain. However, they have relatively poor endurance, payload capacity and speed. Therefore, current UGVs offer either mobility and agility or endurance and payload capacity, but not both.

The present solution provides a mobility platform implementing a hybrid limbed and wheeled approach that offers both of these things. The hybrid limbed and wheeled design comprise four limbs in two pairs (front and back), where the splay of the limbs can be altered by articulating the limbs outward away from the chassis. This enables obstacle climbing, an ability to widen the base width for stable off-road driving, and an ability to narrow the base width for tight spaces. In effect, the present solution has relatively good endurance, payload capacity, speed, improved obstacle climbing, and mobility in unstructured terrain. The solution is described below in greater detail.

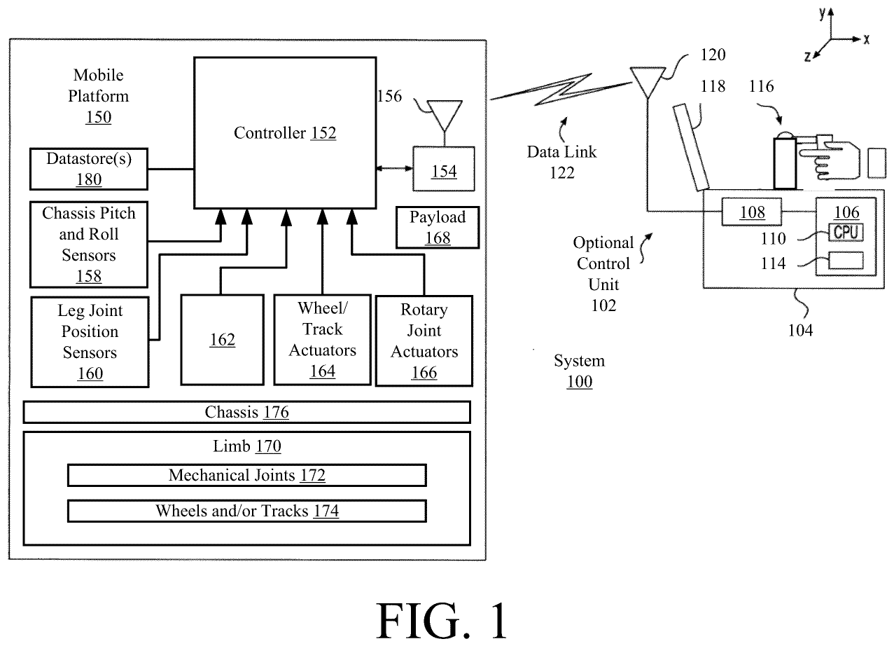

FIG. 1 provides a block diagram showing a system 100 that includes an optional control unit 102 and a mobile platform 150. The illustration of the mobile platform 150 and control unit 102 is not drawn to scale. For example, the mobile platform 150 can be significantly larger than the control unit 102. However, FIG. 1 is sufficient for understanding the present solution, and relationship between the two electronic components 102 and 150.

The mobile platform 150 is a motorized vehicle that operates without an on-board human presence. The mobile platform 150 can be used in various applications, such as site security applications, inspection applications, search and rescue applications, emergency response applications, and/or ISR applications. The mobile platform 150 can include, but is not limited to, a UGV. The UGV can be used to, for example, transport a payload 168 to a particular destination location. The payload 168 can include, but is not limited to, an articulating arm. The mobile platform 150 may be configured to be autonomous, semi-autonomous, and/or remotely controllable via the control unit 102. A data link 122 (e.g., a wireless data link) allows the control system 102 to communicate commands to the mobile platform 150, and allows the control system 102 to receive information from the mobile platform 150. For example, such information can include images from video cameras, haptic feedback data, and other information (e.g., battery related information) pertaining to the operational status of the mobile platform 150.

The control unit 102 can include a user interface control 116, data processing system 106, and a data transceiver 108 to support the data link 122. In some embodiments, user interface control 116 can sense hand movement along two or three linear directions of motion defined by orthogonal axes x, y and z. In this regard, the user interface control 116 can include, but is not limited to, a joystick. Forward movement of the joystick may cause forward movement of the mobile platform 150, while backward movement of the joystick may cause backward movement of the mobile platform 150. Right-side movement of the joystick may cause the mobile platform 150 to turn right, while left-side movement of the joystick may cause the mobile platform 150 to turn left. The present solution is not limited to this manner of controlling the mobile platform's movement. Any known or to be known vehicle motion control technique can be used herein.

Data processing system 106 includes a data processing hardware element 110. The data processing element 110 can include, but is not limited to, a central processing unit (CPU) and/or an application specific integrated circuit (ASIC). The data processing system 106 can also include a memory or data storage device 114 for storing a set of instructions (e.g., software code). The instructions implement one or more of the methodologies, procedures, or functions described herein. The instructions can also reside, completely or at least partially, within the data processing element 110 during execution thereof thereby. The data processing element 110 and memory or data storage device 114 also can constitute machine-readable media.

The data processing system 106 may be fully integrated with the user interface control 116. For example, the data processing system 106 could be integrated into a base 104 associated with the user interface control 116. The data processing system 106 can be operatively connected to a display unit 118 for purposes of displaying video images. The display unit 118 may be integrated with the control system 106 as shown or separate from the control system 106.

Data transceiver 108 is operatively coupled to the data processing system 106. The data transceiver 108 can include any type of wired or wireless transceiver suitable for communicating data to and from a data transceiver 154 of the mobile platform 150. If data transceivers 108, 154 are wireless devices then antennas 120, 156 can be respectively coupled to the data transceivers. A suitable wireless data link interface can be based on any of a variety of well-known wireless interface standards. Examples of such well known wireless interface standards can include the Bluetooth wireless standard, and the IEEE 802.11 family of standards. However, the invention is not limited in this regard and any other wireless interface standard can be used. Data communicated over the data link 122 can include motion control commands directed to mobile platform 150, feedback data communicated from mobile platform 150 to the data processing system 106, and video data communicated from the mobile platform 150 to the data processing system 106.

The mobile platform 150 is a robot system capable of performing moving actions based on commands generated by an onboard controller 152 and/or telematic commands received from remote control unit 102. Onboard controller 152 includes circuitry for generating motion control commands, processing received motion control commands, and/or communicating feedback data to the control unit 102. The circuitry of the onboard controller 152 can include, but is not limited to, microprocessor(s), microcontroller(s), and/or ASIC(s). The circuitry of the onboard controller 152 is communicatively connected to datastore(s) 180 for accessing instructions and/or data useful for controlling operations of the mobile platform 150. The on-board controller 152 is also configured to perform communication operations involving data transceiver 154.

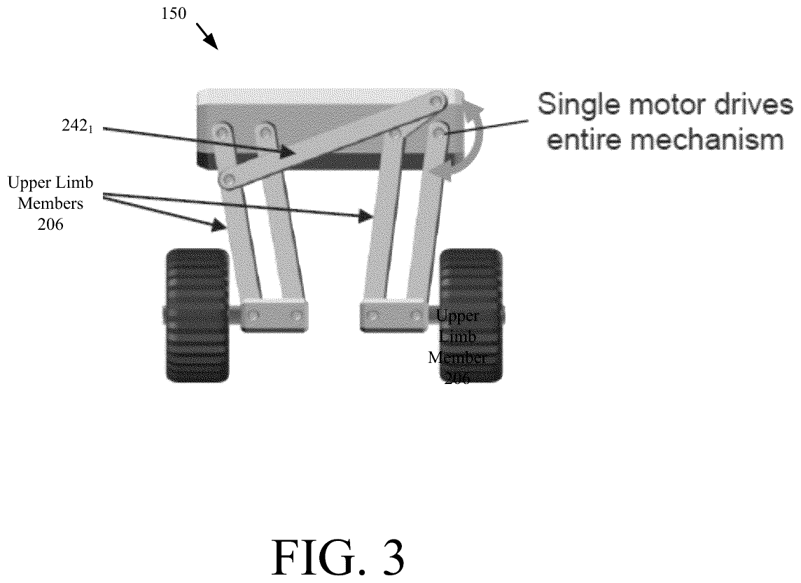

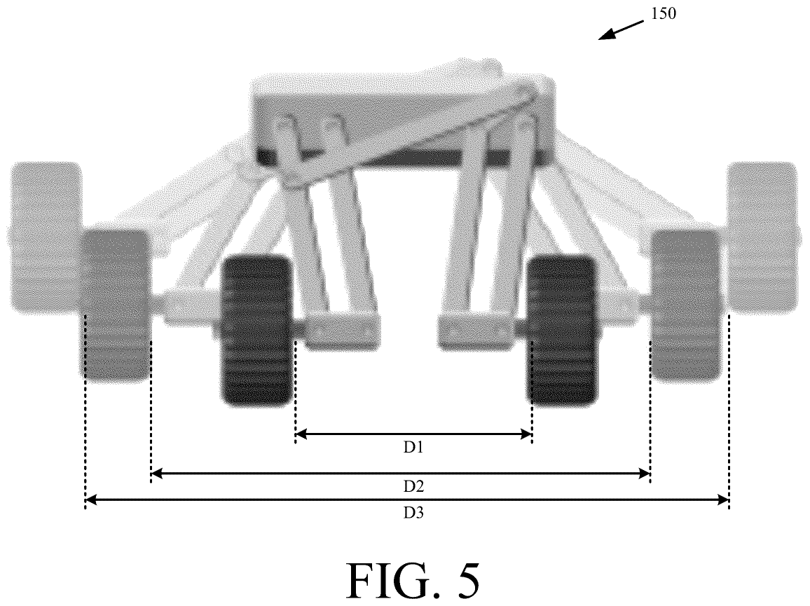

With reference to FIGS. 1-6, mobile platform 150 includes a chassis 176 with four limbs 170₁, 170₂, 170₃, 170₄ (collectively referred to as limbs 170) coupled thereto. Chassis 176 comprises body parts 210₁, 212₁, 212₂, 210₂ that are coupled to each other. Body parts 210₁, 210₂ are collectively referred to as “210”, while body parts 212₁, 212₂ are collectively referred to as “212”. The body parts 210₁, 212₁, 212₂, 210₂ are configured to act like a gimbal to allow movements thereof about a plurality of axes 250₁, 250₂, 254. The present solution is not limited to the particular gimbal design shown in FIGS. 1-6. The body parts can have other designs which allow the chassis to act like a gimbal.

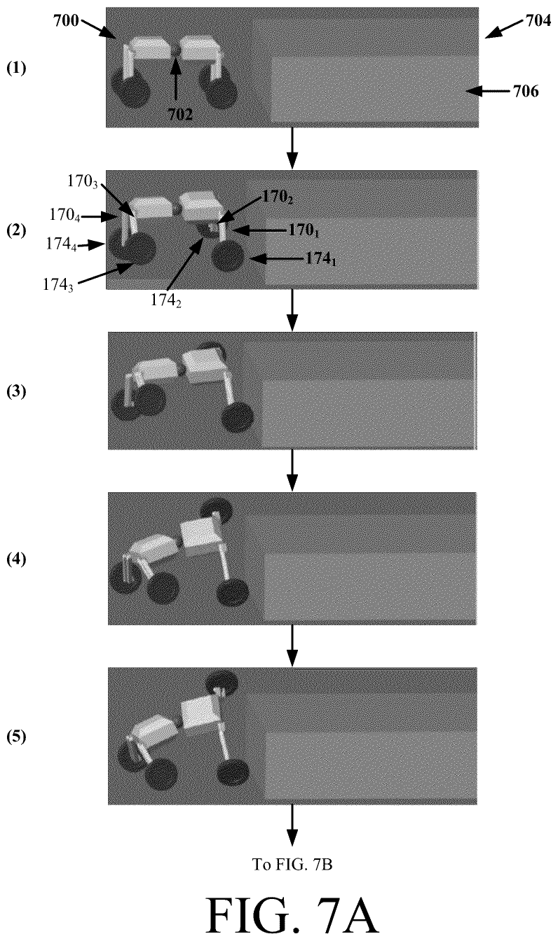

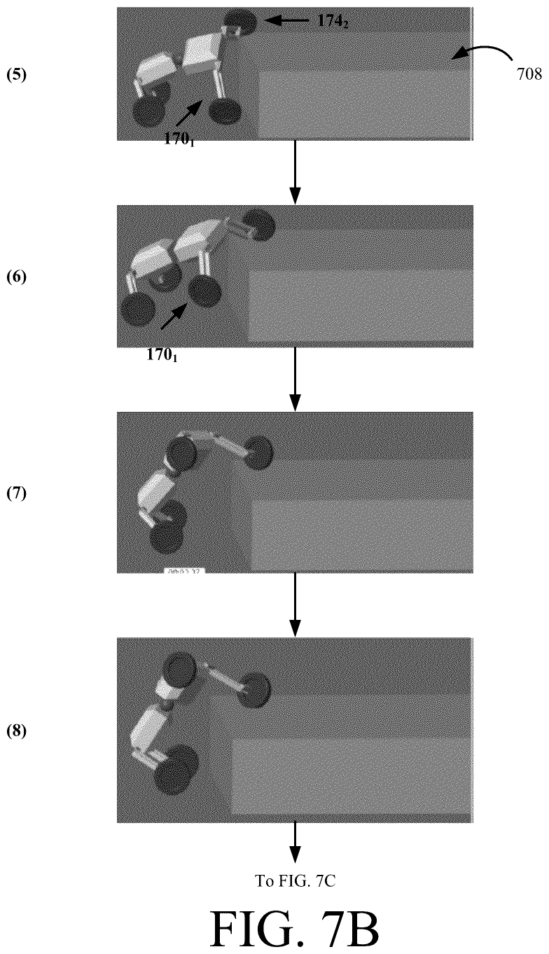

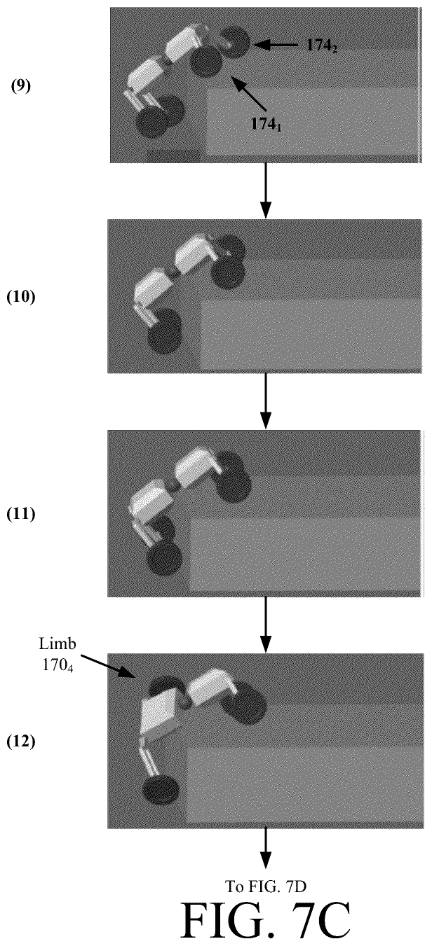

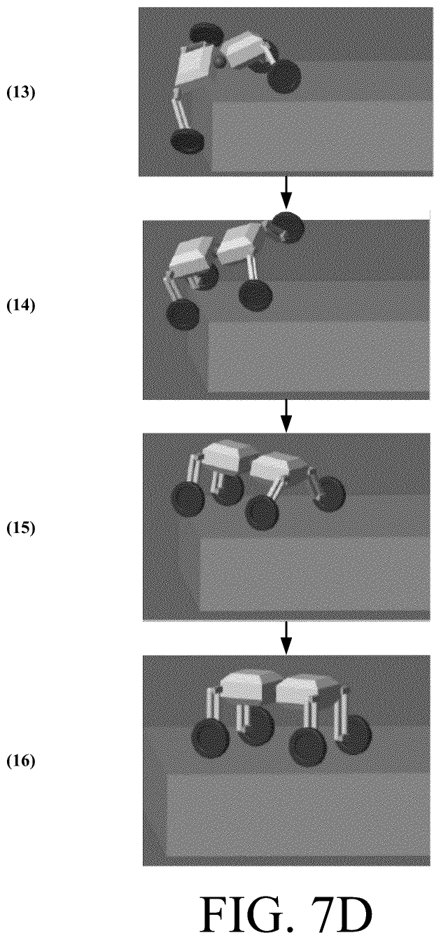

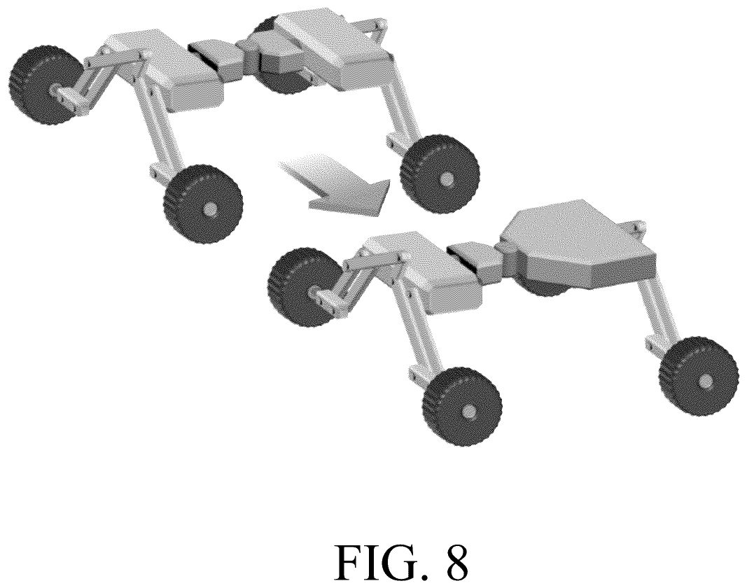

Although four body parts are shown in the drawings, the mobile platform can include any number of body parts selected in accordance with a given application. For example, the mobile platform can include three body parts as shown in FIG. 8 rather than four body parts as shown in FIGS. 1-6. In FIG. 8, body part 212₂ has been eliminated or removed from the mobile platform. Alternatively, a single body part 702 is provided as shown in FIG. 7. Body part 702 may comprise a ball for a ball and socket joint. The mobile platform may optionally be designed to allow the body parts 212₁, 212₂ to be interchanged with body part 702. The chassis design of FIGS. 1-6 is more robust and easier and simpler to actuate than the chassis design of FIG. 7.

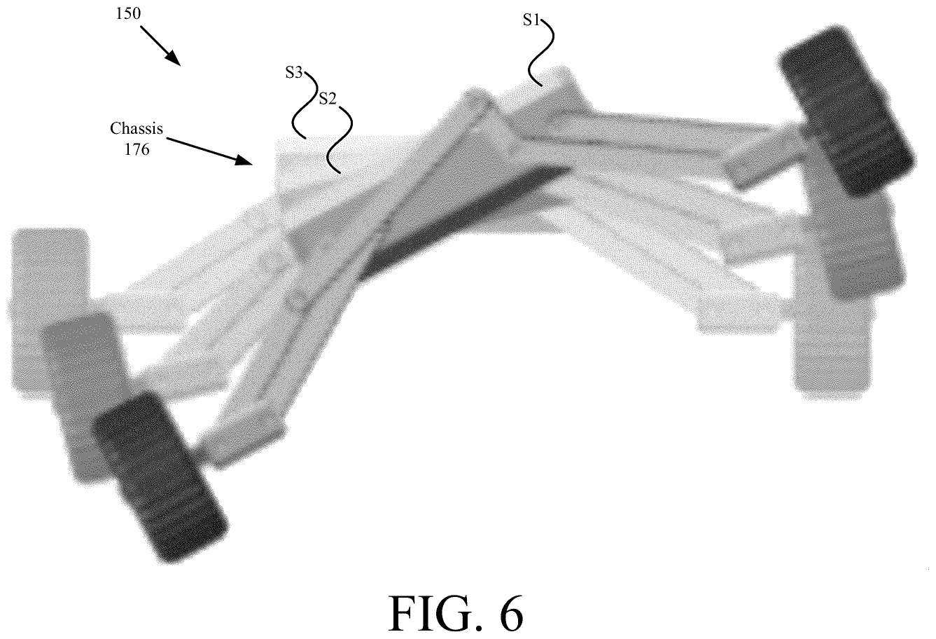

Each body part 210₁, 212₁, 212₂ and 210₂ is configured to be rotatable or twist about a platform centerline or horizontal center axis 250₁, 250₂ independent and separate from any rotation of the other body parts. Additionally, each body part 212₁, 212₂ is configured to rotate about a vertical center axis 254 which extends perpendicular to the horizonal center axis 250₁, 250₂. The rotation of all the body parts can be actively controlled by the controller 152 and/or control unit 102. In some scenarios, one or more body parts can be passive provided that at least one other body part is actively controlled by controller 152 and/or control unit 102. The rotating or twisting of the body parts facilitates the prevention of side-toppling of the mobile platform on uneven terrain as well as climbing obstacles as shown in FIG. 7. The rotation or twisting of the body parts can be achieved using, for example, motor(s), spring(s) and/or damper(s) on each rotary joint 260₁, 260₂, 262 between two adjacent body parts. The motors for rotary joints 260₁, 260₂, 262 can include, but are not limited to, servo motors. The rotation or twisting of the body parts allows the chassis to transition between different twist states S1, S2, S3 as shown in FIG. 6. Machine learning algorithm(s) or model(s) can be used to autonomously control movement of the body parts relative to each other and relative to limb movements to reduce the likelihood of the mobile platform tipping over during operations. The machine learning algorithm(s) or model(s) can include, but are not limited to, neural networks.

Each body part 210₁, 212₁, 212₂ and 210₂ can rotate or pivot N ° or less around each axis 250₁, 250₂, 254 in two opposing directions. N is any number between 1 and 360 selected in accordance with a given application. The body parts can be selectively configured at any time to rotate or pivot around each axis 250₁, 250₂, 254 by the same amount or by different amounts. For example, at a first time, all body parts are configured to rotate N ° around an axis 250₁, 250₂. However, at a second time, body parts 210 is configured to rotate N₁° around an axis 250₁, 250₂, while body parts 212 are configured to rotate N₂° around an axis 250₁, 250₂. N₁ is not equal to N₂. The amount of rotation of one or more body parts can be limited to ensure that (i) the front and/or (ii) the front limbs 170₁, 170₂ do not contact the back limbs 170₃, 170₄ during operation of the mobile platform.

Additionally or alternatively, the amount by which each body part rotates about each axis 250₁, 250₂, 254 can be changed, modified or otherwise adjusted during operation of the mobile platform based on sensor data and/or certain criteria. For example, N is changed from a first value to a different second value based on a change in one or more characteristics of the surrounding environment and/or terrain over which the mobile platform is traveling.

Each axis 250₁, 250₂ extends from a center of the chassis to the front end 230 of the chassis 176 or a backend 232 of the chassis 176. Axes 250₁, 250₂ may be collectively referred to as “250”. Axis 254 extends from a top side 234 of the chassis 176 to a bottom side 236 of the chassis 176. Chassis pitch and roll sensors 158 provide chassis pitch and roll angle information to the controller 152 for use in controlling movement of the limbs 170 and/or body parts 210, 212.

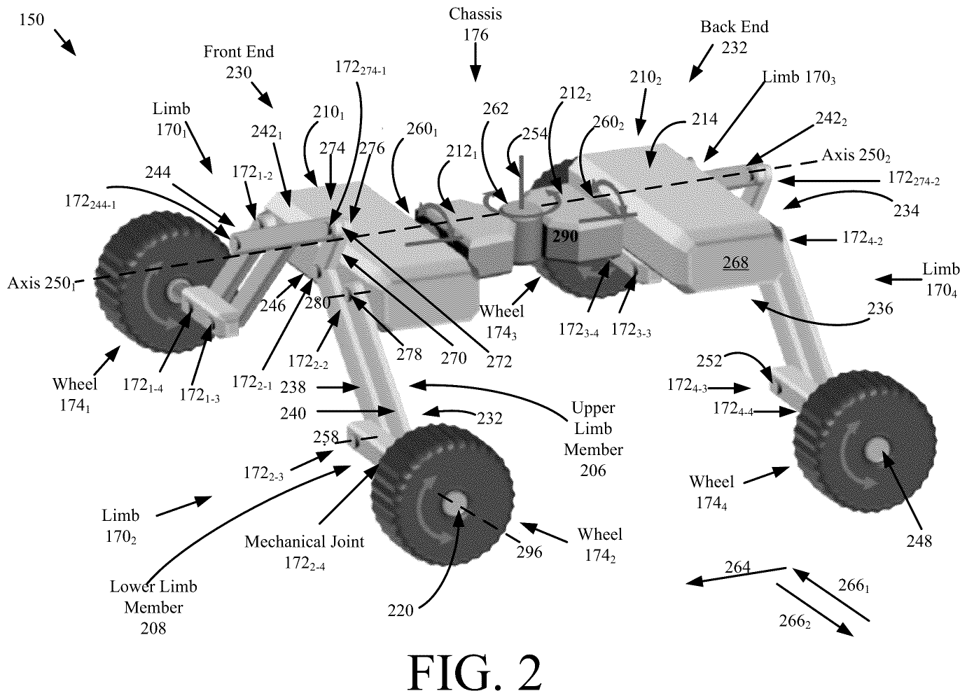

Each limb 170₁, 170₂, 170₃, 170₄ has one or more mechanical joints 172. For example, limb 170₁ comprises mechanical joints 172₁₋₁ (not visible in FIG. 2), 172₁₋₂, 172₁₋₃, 172₁₋₄. Limb 170₂ comprises mechanical joints 172₂₋₁, 172₂₋₂, 172₂₋₃, 172₂₋₄. Limb 170₃ comprises mechanical joints 172₃₋₁, 172₃₋₂ (not visible in FIG. 2), 172₃₋₃, 172₃₋₄. Limb 170₄ comprises mechanical joints 172₄₋₁ (not visible in FIG. 2), 172₄₋₂, 172₄₋₃, 172₄₋₄.

Drive mechanisms are provided to cause movement of the limbs 170. For example, in some scenarios, a motor is provided for actuating each limb independently from the other limbs. However, the present solution is not limited to this design. For example, the mobile platform 150 can have the design shown in FIGS. 1-6 in which a first motor is provided to cause the concurrent or simultaneous actuation of the limbs 170₁, 170₂ of the front pair and a second motor is provided to cause the concurrent or simultaneous actuation of the limbs 170₃, 170₄ of the back pair. This reduced motor design is achieved, for example, using limb link members 242₁, 242₂. The present solution is not limited to the particular limb link member configurations shown in FIGS. 2-6. Other mechanisms can be used to achieve the same result of the concurrent or simultaneous actuation of the back or rear limbs. For example, telescoping member can be provided at the shoulders or points of articulations between the limbs and chassis.

Limb link member 242₁ is provided at the front end 230 of the chassis 176 and limb link member 242₂ is provided at the back end 232 of the chassis 176. The limb link members 242₁, 242₂ allow for the reduced total number of motors needed to actuate the limbs 170₁, 170₂, 170₃, 170₄. In this regard, limb link member 242₁ mechanically connects or links limbs 170₁ and 170₂ to each other, while limb link member 242₂ mechanically connects or links limbs 170₃ and 170₄ to each other. A first end 244 of limb link member 242₁ is pivotally connected to an outer bar 240 of an upper limb member 206 of limb 170₁. A second end 246 of limb link member 242₁ is pivotally connected to an inner bar 238 of an upper limb member 206 of limb 170₂. Similarly, a first end 244 of limb link member 242₂ is pivotally connected to an outer bar 240 of an upper limb member 206 of limb 170₃. A second end 246 of limb link member 242₂ is pivotally connected to an inner bar 238 of an upper limb member 206 of limb 170₄.

Each limb link member 242₁, 242₂ comprises two bars 270, 272 pivotally connected to each other at adjacent ends 274, 276 thereof. The opposing end 244 of bar 272 is pivotally connected to the outer bar 240 of the upper limb member 206 of limb 170₁. The opposing end 246 of bar 270 is pivotally connected to the inner bar 238 of an upper limb member 206 of limb 170₂. This configuration allows for a single rotary joint actuator 166 to cause the simultaneous or concurrent movement of limbs 170₁ and 170₂ via rotation of outer bar 240 about mechanical joint 172₂₋₂.

Each mechanical joint 172₁₋₁, 172₁₋₂, 172₂₋₁, 172₂₋₂, 172₂₋₁, 172₂₋₂, 172₄₋₁, 172₄₋₂ is provided at the point of articulation between the chassis 176 and the respective bar 238, 240 of the respective upper limb member 206. At each point of articulation, a proximal end 230 of the respective bar 238, 240 is rotatably or pivotably coupled to the chassis 176 via a coupling means 278. Coupling means 278 can include, but is not limited to, an axel, a pin, a shaft, gear(s), and/or a ball and socket. Each bar 238, 240 of the upper limb member 206 can rotate 360° or less around an axis 280 which extends through the respective point of articulation. In this regard, an elongate body of the upper limb member 206 may extend parallel to axes 280 at a first time, extend perpendicular to axes 280 at a second time, and otherwise extend in a direction that is angled relative to axes 280 at a third time.

Each mechanical joint 172₁₋₃, 172₁₋₄, 172₂₋₃, 172₂₋₄, 172₃₋₃, 172₃₋₄, 172₄₋₃, 172₄₋₄ is provided at a point of articulation where the respective upper limb member 206 meets the respective lower limb member 208. At this point of articulation, a distal end 232 of the upper limb member 206 is rotatably or pivotably coupled to the lower limb member 208 via a coupling means 252. Coupling means 252 can include, but is not limited to, an axel, a pin, a shaft, gear(s), and/or a ball and socket.

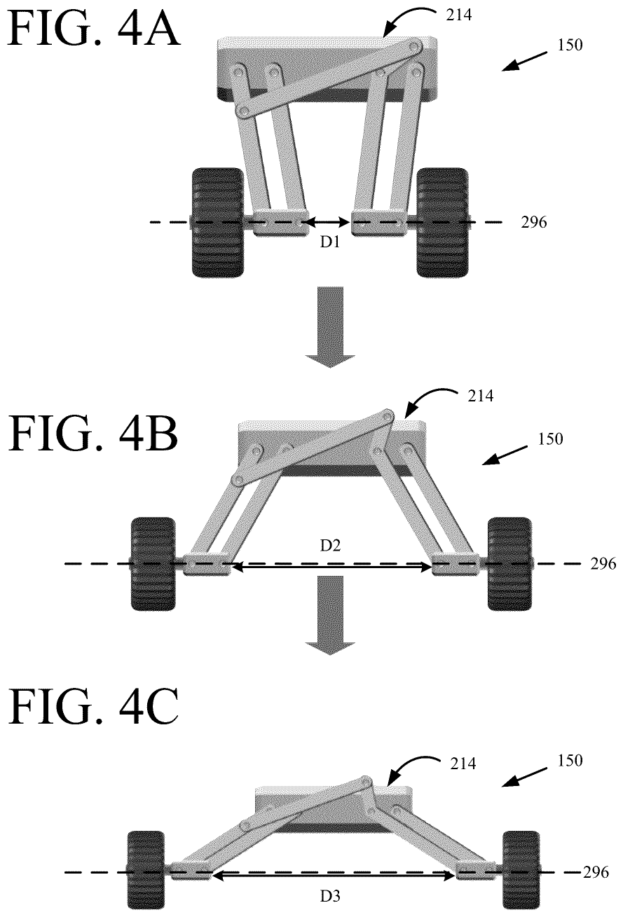

Each bar 238, 240 of the upper limb member 206 can rotate M ° around an axis 258 which extends through a respective point of articulation with the lower limb member 208. M is any number between 1 and 180. If M is 180, then an elongate body of the upper and lower limb members 206, 208 may extend parallel to axis 250₁, 250₂ at a first time, extend perpendicular to axis 250₁, 250₂ at a second time, and otherwise extend in a direction that is angled relative to axis 250₁, 250₂ at a third time. Illustrations are provided in FIGS. 4A-4C which show different relative positions of the mechanical joints due to rotations thereof. As seen in FIGS. 4A-4C, the distance between limbs of a given pair can be selectively narrowed to a value D1 and selectively widened to a value D2. The distance can further be widened to a value D3. It should be noted that the upper and lower limb member design shown in FIGS. 2-9 have a geometry similar to a parallelogram, where the distance between upper joints (e.g., 172₂₋₁ and 172₂₋₂) and the distance between lower joints (e.g., 172₂₋₃ and 172₂₋₄) are substantially equal and also the distance between joints on the inner link (e.g., 172₂₋₁ and 172₂₋₃) and the distance between joints on the outer link (e.g., 172₂₋₂ and 172₂₋₄) are substantially equal. This geometry allows a center axis 296 of each wheel 174₁, 174₂, 174₃, 174₄ to remain parallel with the upper surfaces 214 of body parts 210₁, 210₂ while traveling over any type of terrain.

Movement of at least mechanical joints 172₂₋₂, 172₃₋₂ are controlled by controller 152 and/or control unit 102. Rotary joint actuators 166 are provided to facilitate movement of the limbs 170 in accordance with motion control command signals. The rotary joint actuators 166 can include, but are not limited to, servo motors. Limb joint position sensors 160 provide position information with regard to one or more of the mechanical joints 172. This position information is communicated from the limb joint position sensors 160 to the controller 152 and/or the control unit 102. A limb joint position sensor can be provided at one or more mechanical joints of each leg in accordance with any given application. The mechanical joints of the legs are referenced by numbers 172₁₋₁, 172₁₋₂, 172₁₋₃, 172₁₋₄, 172₂₋₁, 172₂₋₂, 172₂₋₃, 172₂₋₄, 172₃₋₁, 172₃₋₂, 172₃₋₃, 172₃₋₄, 172₄₋₁, 172₄₋₂, 172₄₋₃, 172₄₋₄, 172₂₄₄₋₁, 172₂₄₄₋₂ (not visible in FIG. 2), 172₂₇₄₋₁, 172₂₇₄₋₂.

The mobile platform 150 also includes other movable elements in the form of wheels and/or tracks 174. In FIG. 2, each limb 170₁, 170₂, 170₃, 170₄ of the mobile platform 150 comprises a wheel 174₁, 174₂, 174₃, or 174₄ (collectively referred to as wheels “174”) pivotally connected thereto via a coupler 220. Couplers 220 can include, but are not limited to, axels, pins, shafts, and/or gears. Each wheel 174₁, 174₂, 174₃, 174₄ can rotate 360° in two opposing directions around a respective wheel pivot point 248.

The mobile platform 150 further comprises wheel/track actuators 164. The wheel/track actuators 164 can include, but are not limited to, variable-speed, reversible electric motors mounted inside the chassis 176. Each wheel may be actively rotated via the wheel/track actuators 164. In one scenario, one or more of the wheels can rotate freely. In another scenarios, none of the wheels can rotate freely. One of the actuators 164 may be coupled to wheel 174₁ so that activation of this motor causes wheel 174₁ to rotate. Another one of the actuators 164 may be coupled to the rear wheel 174₂ so that activation of this motor causes the wheel 174₂ to rotate. Yet another one of the actuators 164 may be coupled to the rear wheel 174₃ so that activation of this motor causes the wheel 174₃ to rotate, while another one of the actuators 164 may be coupled to the rear wheel 174₄ so that activation of this motor causes the wheel 174₄ to rotate. Movement of the wheels 174₁, 174₂, 174₃, 174₄ by actuators 164 may be controlled by movement command signals from controller 152 and/or control unit 102.

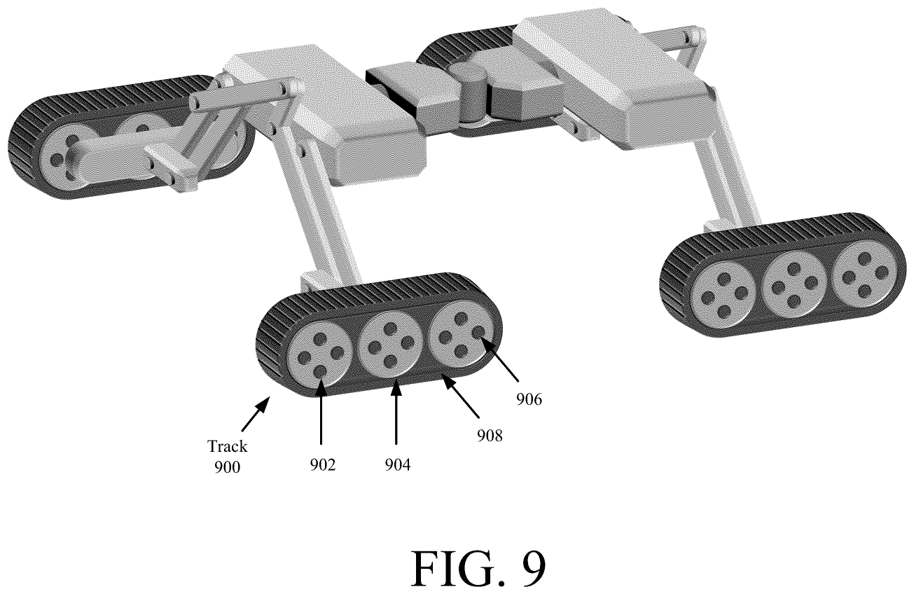

The wheels 174 may be optionally replaced or interchanged with a track 900 as shown in FIG. 9. Track 900 comprises wheels 902, 904, 906 coupled by way of a tread 908. Rotation of wheel 904 drives the tread 908, which in turn causes the outer wheels 902, 906 to rotate. Movement of the wheel 904 may be controlled by movement command signals from controller 152 and/or control unit 102. The tracks 900 allow the mobile platform to be selectively configured for improved operation in soft soil, mud and/or snow.

Other sensors 162 may be provided with the mobile platform 150 to indicate movement of the wheels 174, 906. Sensors 162 can include, but are not limited to, optical encoders, magnetic encoders, potentiometers, and resolvers. The outputs from the sensors 162 may be used by the controller 152 and/or control unit 102 for controlling movements of the mobile platform 150. Sensors 162 may also include environmental sensors, camera(s), a lidar system, and/or a radar system. These sensors can be used to detect characteristics of a surrounding environments and/or detect objects in proximity to the mobile platform 150. Any known or to be known object detection technique can be used here.

The position of the mobile platform 150 is controlled through the selective activation and deactivation of the actuators 164 in response to control inputs generated by controller 152 and/or control unit 102. Linear or straight-line travel of the mobile platform 150 is effectuated by the simultaneous activation of actuators 164 in the same direction and at the same speed so as to drive wheels and tracks 174 in the same direction and at the same speed. Turning of the mobile platform 150 may be achieved by, for example: (1) simultaneously activating the actuators for wheels of the limbs 170₁, 170₃ on a first side of the mobile platform 150 and actuators for wheels of the limbs 170₂, 170₄ on a second side of the mobile platform 150 in opposite directions or in the same direction at different speeds; or (2) operating actuators for only one of the limbs.

FIGS. 7A-7D provide illustrations showing a series of movements of a mobile platform 700 over uneven terrain 704. Mobile platform 150 is configured to move in a similar manner as mobile platform 700 shown in FIGS. 7A-7D. As shown in FIGS. 7A-7D, operations of the mobile platform 700 involve: (1) driving into proximity of an obstacle 706 of the terrain 704; (2) twisting the body part(s) of the chassis around the platform centerline 250₁, 250₂ and rotating limbs 170₂, 170₃ outwards to lift wheels 174₂, 174₃ off the ground; (3) further twist the body part(s) of the chassis around the platform centerline 250₁, 250₂ and further rotate limbs 170₂, 170₃ outwards to further lift wheels 174₂, 174₃ off the ground; (4) rotating the body part(s) in a first direction about axis 254 such that the chassis has a bent configuration (i.e., the centerlines of the body parts 210₁, 210₂ are angled relative to each other); (5) drive towards the obstacle 706 until the lifted wheel 174₂ comes in contact with a top surface 708 of the obstacle 706; (6) rotate the body part(s) in an opposing second direction about axis 254 such that the chassis no longer has a bent configuration; (7) rotate the body part(s) around the platform centerline 250; (8) drive forwards so that wheel 174₂ rolls on the top surface 708 of the obstacle 706 and wheels 174₃, 174₄ move closer to the obstacle 706; (9) rotate the body part(s) around the platform centerline 250 until wheel 174₁ comes in contact with the top surface 708 of the obstacle 706; (10, 11) drive forwards so that wheels 174₁, 174₂ roll on the top surface 708 of the obstacle 706; (12, 13) rotate the body part(s) around axis 250₁, 250₂ and axis 254 while widening the stance between limbs 170₂ and 170₄; (13) drive forwards so that wheels 174₁, 174₂, 174₄ roll on the top surface 708 of the obstacle 706; (14) continue to drive forwards so that wheel 174₃ comes in contact with and all four wheels roll on the top surface 708 of the obstacle 706; and (15, 16) continue to drive forwards so that the mobile platform 700 drives on the top surface 708 of the obstacle 706.

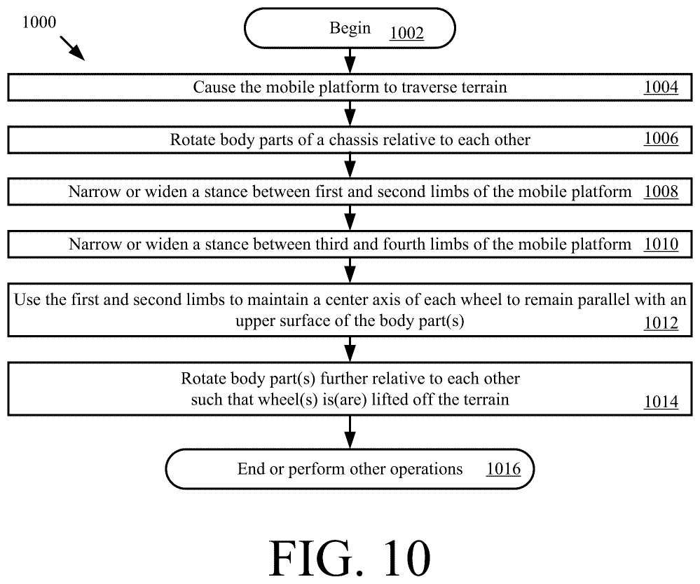

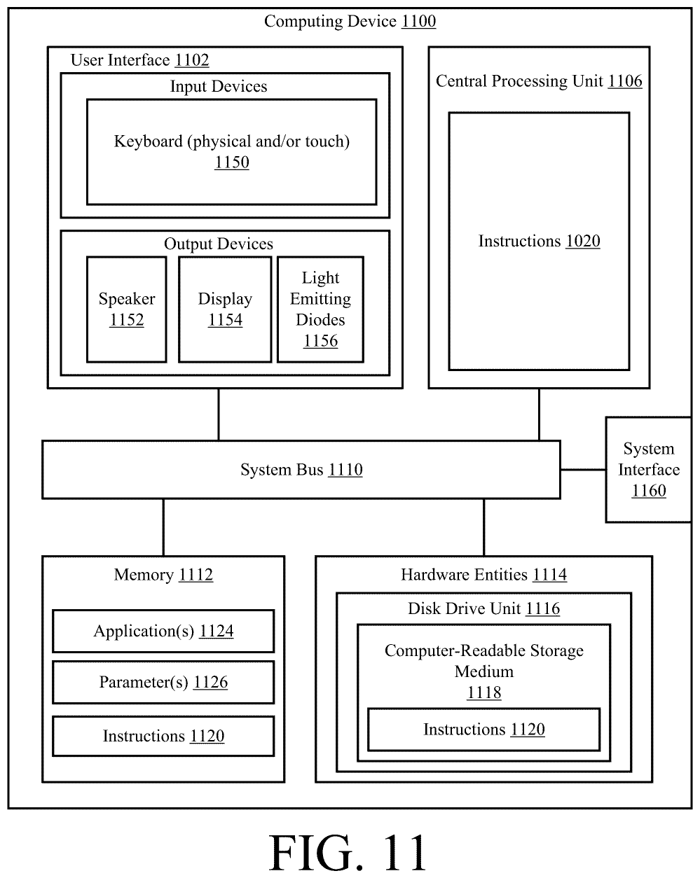

FIG. 10 provides a flow diagram of an illustrative method 2000 for controlling or otherwise operating a mobile platform (e.g., mobile platform 150 of FIGS. 1-6 or 700 of FIG. 7). Method 1000 begins with 1002 and continues with 1004 where a circuit (e.g., control unit 102, controller 152, actuators 164, transceiver 154, and/or wheels and/or tracks 174 of FIG. 1) cause the mobile platform to traverse terrain (e.g., terrain 704 of FIG. 7). This may be achieved, for example, by causing the mobile platform to travel forwards or backwards. Movement of the mobile platform can involve actuating one or more wheels (e.g., wheel 174₁, 174₂, 174₃ and/or 174₄ of FIGS. 1-2) connected to one or more limbs (e.g., limbs 170₁, 170₂, 170₃ and/or 170₄ of FIGS. 1-2) thereof. Actuation of each wheel may be performed independent of actuation of the other wheels. Additionally or alternatively, two or more of the wheels may be actuated simultaneously as a pair of wheels (e.g., a pair of the front wheels 174₁, 174₂ or a pair of back wheels 174₃, 174₄).

Next in 1006, body parts (e.g., body parts 210₁, 210₂, 212₁ and/or 212₂ of FIGS. 2-6) of a chassis (e.g., chassis 176 of FIGS. 2-6) are rotated relative to each other as the mobile platform traverses the terrain. As such, the body parts may rotate while the mobile platform is driving over the terrain, while the mobile platform is climbing over the terrain, and/or while the mobile platform is stationary on the terrain. The chassis extends in a longitudinal direction (e.g., direction 264 of FIG. 2) from a back end (e.g., back end 232 of FIG. 2) of the mobile platform to a front end (e.g., front end 230 of FIG. 2) of the mobile platform and extends in lateral directions (e.g., directions 266₁, 266₂ of FIG. 2) from a platform centerline (e.g., line 250 of FIG. 2) to two opposing lateral sides (e.g., lateral sides 268 of FIG. 2) of the mobile platform.

The rotation of the body parts may involve actuating a first rotational joint (e.g., rotational joint 260₁ or 260₂ of FIG. 2) with a rotational joint axis (e.g., axis 290 of FIG. 2) oriented along the platform centerline (e.g., line 250 of FIG. 2) and actuating a second rotational joint (e.g., rotational joint 262 of FIG. 2) with a rotational joint axis (e.g., axis 254 of FIG. 2) orientated perpendicular to the platform centerline. In this way, the body parts may roll and yaw with respect to each other. The term “roll”, as used here, refers to rotational, twisting and/or oscillating movement around or about axis 290. The term “yaw”, as used here, refers to rotational, twisting and/or oscillating movement around or about axis 254. Axis 290 may be referred to as a roll axis, while axis 254 may be referred to as a yaw axis.

In 1008, a stance between first and second limbs (e.g., limbs 170₂ and 170₁ of FIG. 2) of the mobile platform is narrowed or widened. This can be achieved by actuating at least a first mechanical joint (e.g., mechanical joint 172₂₋₂ of FIG. 2) provided at a first point of articulation between the chassis and an upper limb member (e.g., upper limb member 206 of FIG. 2) of the first limb (e.g., limb 170₂ of FIG. 2) that is coupled to the chassis. The narrowing or widening of the stance may be achieved by movement of the first limb (e.g., limb 170₂ of FIG. 1) in a first direction towards or away (e.g., direction 266₁ or 266₂ of FIG. 2) from the platform centerline (e.g., line 250 of FIG. 2) and movement of the second limb (e.g., limb 170₁ of FIG. 1) in an opposing second direction (e.g., direction 266₁ or 266₂ of FIG. 2). The movement of the first limb is motorized movement. A linkage (e.g., limb link members 242₁ or 242₂ of FIG. 2) may be provided so that the motorized movement of the first limb is used to also cause the movement of the second limb to concurrently occur. In this way, movement of the second limb may be responsive to and caused by movement of the first limb.

The operations of blocks 1006 and 1008 may be performed sequentially or at the same time. In the later case, the mobile platform may climb onto an obstacle (e.g., obstacle 706 of FIG. 7) rather than drive onto the obstacle. The mobile platform may continue to climb over the obstacle or drive on the obstacle depending on the obstacle's characteristics (e.g., shape, size and/or surface texture).

In 1010, a stance between third and fourth limbs (e.g., limbs 170₄, 170₃ of FIG. 2) of the mobile platform is narrowed or widened. This can be achieved by actuating at least a second mechanical joint (e.g., mechanical joint 172₄₋₂ of FIG. 2) provided at a second point of articulation between the chassis and an upper limb member (e.g., upper limb member 206 of FIG. 2) of the third limb (e.g., limb 170₄ of FIG. 2) that is coupled to the chassis. The first and second limbs may comprise a first pair of limbs, and the third and fourth limbs comprise a second pair of limbs. The stance of the front pair of limbs may be narrowed and widened independent from the narrowing or widening of the stance of a second pair of limbs.

In 1012, the first and second limbs are used to maintain a center axis (e.g., center axis 296 of FIG. 2) of each wheel (e.g., wheel 174₁, 174₂, 174₃ or 174₄ of FIG. 2) to remain parallel with an upper surface (e.g., upper surface 214 of FIG. 2) of at least one body part (e.g., body part 210₁ and/or 210₂ of FIG. 2) while the mobile platform travels over terrain. 1014 involves rotating the body part(s) of the chassis further relative to each other such that one or more wheels are lifted off the terrain over which the mobile platform is traveling. Subsequently, method 1000 continues with 1026 where it ends or other operations are performed (e.g., return to 1002).

Referring now to FIG. 11, there is provided an illustration of an illustrative architecture for a computing device 1100. The controller 106 of FIG. 1 and/or controller 152 of FIG. 1 is/are the same as or similar to computing device 1100. As such, the discussion of computing device 1100 is sufficient for understanding the controllers 106, 152 of FIG. 1.

Computing device 1100 may include more or less components than those shown in FIG. 10. However, the components shown are sufficient to disclose an illustrative solution implementing the present solution. The hardware architecture of FIG. 11 represents one implementation of a representative computing device configured to operate a vehicle, as described herein. As such, the computing device 1100 of FIG. 11 implements at least a portion of the method(s) described herein.

Some or all components of the computing device 1100 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 11, the computing device 1100 comprises a user interface 1102, a central processing unit (CPU) 1106, a system bus 1110, a memory 1112 connected to and accessible by other portions of computing device 1100 through system bus 1110, a system interface 1160, and hardware entities 1114 connected to system bus 1110. The user interface can include input devices and output devices, which facilitate user-software interactions for controlling operations of the computing device 1100. The input devices include, but are not limited to, a physical and/or touch keyboard 1150. The input devices can be connected to the computing device 1100 via a wired or wireless connection (e.g., a Bluetooth® connection). The output devices include, but are not limited to, a speaker 1152, a display 1154, and/or light emitting diodes 1156. System interface 1160 is configured to facilitate wired or wireless communications to and from external devices (e.g., network nodes such as access points, etc.).

At least some of the hardware entities 1114 perform actions involving access to and use of memory 1112, which can be a random access memory (RAM), a disk drive, flash memory, a compact disc read only memory (CD-ROM) and/or another hardware device that is capable of storing instructions and data. Hardware entities 1114 can include a disk drive unit 1116 comprising a computer-readable storage medium 1118 on which is stored one or more sets of instructions 1120 (e.g., software code) configured to implement one or more of the methodologies, procedures, or functions described herein. The instructions 1120 can also reside, completely or at least partially, within the memory 1112 and/or within the CPU 1106 during execution thereof by the computing device 1100. The memory 1112 and the CPU 1106 also can constitute machine-readable media. The term “machine-readable media”, as used here, refers to a single medium or multiple media (e.g., a centralized or distributed database, and/or associated caches and servers) that store the one or more sets of instructions 1120. The term “machine-readable media”, as used here, also refers to any medium that is capable of storing, encoding or carrying a set of instructions 1120 for execution by the computing device 1100 and that cause the computing device 1100 to perform any one or more of the methodologies of the present disclosure.

As evident from the above discussion, the present solution concerns mobile platforms. The mobile platforms may comprise: a chassis which extends in a longitudinal direction from a back end to a front end and extends in lateral directions from a platform centerline to two opposing lateral sides, the chassis comprising a plurality of body parts configured to rotate relative to each other; a plurality of limbs coupled to the chassis (wherein each limb comprises an upper limb member, a lower limb member, at least one first mechanical joint provided at a first point of articulation between the chassis and the upper limb member, and at least one second mechanical joint provided at a second point of articulation where the upper limb member meets the lower limb member); and a plurality of wheels connected to the low limb members of the limbs. Each limb is movable in a first direction towards the platform centerline and an opposing second direction away from the platform centerline such that a stance of a front or rear pair of limbs can be selectively narrowed and widened. The stance of the front pair of limbs may be narrowed and widened independent from any narrowing or widening of the stance of the rear pair of limbs.

The body parts may be joined by at least one rotational joint. The body parts may comprise a front body part, a rear body part, and at least one intermediary body part connected between the front and rear body parts. The chassis may comprise a first rotational joint with a rotational joint axis oriented along the platform centerline and a second rotational joint with a rotational joint axis orientated perpendicular to the platform centerline, whereby the plurality of body parts can roll and yaw with respect to each other. The first and second rotational joints may be motorized.

The mobile platforms may also comprise a mechanical coupling between first and second limbs of the front or rear pair such that if the first limb is articulated in a first direction towards or away from the platform centerline of the chassis the second limb moves in an opposing second direction. For example, a first limb link member may be provided that mechanically links first and second limbs of the front pair so that actuation of the first limb causes the concurrent or simultaneous actuation of the second limb, and a second limb link member may be provided to mechanically link third and fourth limbs of the rear pair so that actuation of the third limb causes the concurrent or simultaneous actuation of the fourth limb.

The wheels maybe independently actuated. The wheels may be interchangeable with tracks or are configured to have tracks installed thereon. The upper and lower limb members may be configured to allow a center axis of each of the plurality of wheels to remain parallel with an upper surface of at least one of the plurality of body parts while the mobile platform travels over terrain.

The above described mobile platforms have a novel configuration of system elements. The unique mechanical design enables unique mobility performance—traditional wheeled mobility, adjustable width for varying terrain stability, and whole-body movement for stepping and climbing over obstacles. The present solution achieves a combination mobility, endurance and payload capacity. The mobile platforms are able to: perform off-road driving with wheels that is relatively efficient; capable of carrying relatively heavy payloads because the primary mobility mode is wheeled driving rather than walking; and has an advanced mobility achieved with whole-body movement that provides an ability to traverse a relatively wide range of obstacles.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with a particular implementation is included in at least one embodiment. Thus, discussions of the features and advantages, and similar language, throughout the specification may, but do not necessarily, refer to the same embodiment.

Furthermore, the described features, advantages and characteristics disclosed herein may be combined in any suitable manner. One skilled in the relevant art will recognize, in light of the description herein, that the disclosed systems and/or methods can be practiced without one or more of the specific features. In other instances, additional features and advantages may be recognized in certain scenarios that may not be present in all instances.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

Although the systems and methods have been illustrated and described with respect to one or more implementations, equivalent alterations and modifications will occur to others skilled in the art upon the reading and understanding of this specification and the annexed drawings. In addition, while a particular feature may have been disclosed with respect to only one of several implementations, such feature may be combined with one or more other features of the other implementations as may be desired and advantageous for any given or particular application. Thus, the breadth and scope of the disclosure herein should not be limited by any of the above descriptions. Rather, the scope of the invention should be defined in accordance with the following claims and their equivalents.

We claim:

1. A mobile platform, comprising:
a chassis which extends in a longitudinal direction from a back end to a front end and extends in lateral directions from a platform centerline to two opposing lateral sides, the chassis comprising a plurality of body parts configured to rotate relative to each other;
a plurality of limbs coupled to the chassis; and
a plurality of wheels respectively connected to the plurality of limbs;
wherein each limb of the plurality of limbs is movable in a first direction towards the platform centerline and an opposing second direction away from the platform centerline such that a stance of a front or rear pair of limbs can be selectively narrowed and widened.

2. The mobile platform according to claim 1, wherein the body parts are joined by at least one rotational joint.

3. The mobile platform according to claim 1, wherein the body parts comprise a front body part, a rear body part, and at least one intermediary body part connected between the front and rear body parts.

4. The mobile platform according to claim 1, wherein the chassis comprises a first rotational joint with a rotational joint axis oriented along the platform centerline and a second rotational joint with a rotational joint axis orientated perpendicular to the platform centerline, whereby the plurality of body parts can roll and yaw with respect to each other.

5. The mobile platform according to claim 4, wherein the first and second rotational joints are motorized.

6. The mobile platform according to claim 1, further comprising a mechanical coupling between first and second limbs of the front or rear pair such that if the first limb is articulated in a first direction towards or away from the platform centerline of the chassis the second limb moves in an opposing second direction.

7. The mobile platform according to claim 1, further comprising a first limb link member mechanically linking first and second limbs of the front pair so that actuation of the first limb causes the concurrent or simultaneous actuation of the second limb, and a second limb link member mechanically linking third and fourth limbs of the rear pair so that actuation of the third limb causes the concurrent or simultaneous actuation of the fourth limb.

8. The mobile platform according to claim 1, wherein the stance of the front pair of limbs is configured to be narrowed and widened independent from any narrowing or widening of the stance of the rear pair of limbs.

9. The mobile platform according to claim 1, wherein each of the plurality of wheels is independently actuated.

10. The mobile platform according to claim 1, wherein the plurality of wheels are interchangeable with tracks or are configured to have tracks installed thereon.

11. The mobile platform according to claim 1, wherein the plurality of limbs are configured to allow a center axis of each of the plurality of wheels to remain parallel with an upper surface of at least one of the plurality of body parts while the mobile platform travels over terrain.

12. The mobile platform according to claim 1, wherein the plurality of body parts of the chassis are configured to rotate relative to each other such that one or more of the plurality of wheels are lifted off the terrain over which the mobile platform is traveling.

13. A method for controlling a mobile platform, comprising:
causing, by a circuit, the mobile platform to traverse terrain;
rotating a plurality of body parts of a chassis relative to each other as the mobile platform traverses the terrain, the chassis extending in a longitudinal direction from a back end of the mobile platform to a front end of the mobile platform and extending in lateral directions from a platform centerline to two opposing lateral sides of the mobile platform; and
narrowing or widening a stance between first and second limbs of the mobile platform by actuating at least a first mechanical joint provided at a first point of articulation between the chassis and the first limb that is coupled to the chassis.

14. The method according to claim 13, wherein said rotating and actuating are performed at the same time such that the mobile platform climbs onto an obstacle rather than drive onto the obstacle.

15. The method according to claim 13, wherein said narrowing or widening of the stance is achieved by movement of the first limb in a first direction towards or away from the platform centerline and movement of the second limb in an opposing second directions.

16. The method according to claim 15, wherein the movement of the first limb is motorized movement and a linkage is provided so that the motorized movement of the first limb is used to also cause the movement of the second limb to concurrently occur.

17. The method according to claim 13, wherein said rotating the plurality of body parts of the chassis comprises actuating a first rotational joint with a rotational joint axis oriented along the platform centerline and actuating a second rotational joint with a rotational joint axis orientated perpendicular to the platform centerline, whereby the plurality of body parts roll and yaw with respect to each other.

18. The method according to claim 13, further comprising:
narrowing or widening a stance between third and fourth limbs of the mobile platform by actuating at least a second mechanical joint provided at a second point of articulation between the chassis and the third limb that is coupled to the chassis;
wherein the first and second limbs comprise a first pair of limbs, the third and fourth limbs comprise a second pair of limbs, and the stance of the front pair of limbs is narrowed and widened independent from the narrowing or widening of the stance of a second pair of limbs.

19. The method according to claim 13, further comprising using the first and second limbs to maintain a center axis of each of a plurality of wheels to remain parallel with an upper surface of at least one of the plurality of body parts while the mobile platform travels over terrain.

20. The method according to claim 13, further comprising rotating a plurality of body parts of a chassis further relative to each other such that one or more of a plurality of wheels are lifted off the terrain over which the mobile platform is traveling.
